(19) United States
(12) Patent Application Publication
(10) Pub. No.: US 2025/0167643 A1
(43) Pub. Date: May 22, 2025

(54) Method and Device for Producing Laminated Cores

(71) Applicant: voestalpine Automotive Components Dettingen GmbH & Co. KG, Dettingen an der Ems (DE)

(72) Inventors: Heinrich Bursy, Erkenbrechtsweiler (DE); Tony Joost, Zwickau (DE); Jochen Lanksweirt, Heidenheim (DE)

(73) Assignee: voestalpine Automotive Components Dettingen GmbH & Co. KG, Dettingen an der Ems (DE)

(21) Appl. No.: 18/836,620

(22) PCT Filed: Dec. 8, 2022
(86) PCT No.: PCT/EP2022/085071

§ 371 Date: Aug. 7, 2024

(30) Foreign Application Priority Data
Feb. 7, 2022 (DE) 10 2022 102 821.6

(51) Int. Cl. H02K 15/0273

(52) U.S. Cl. CPC H02K 15/0273

(57) ABSTRACT

The invention relates to a method for stamping and forming packs of sheet metal laminations coated with a bonding varnish to form lamination packs, wherein a brake sleeve is provided in which the sheet metal laminations of the lamination packs, lying on top of one another and with outer edges resting against the inside of the brake sleeve, are acted on with heat from the brake sleeve via the outer edges of the sheet metal laminations so that the bonding varnish is thermally activated, bonding the laminations to one another, characterized in that an additional device for heating the lamination packs is at least temporarily positioned in an axial channel formed by the lamination packs in order to additionally heat the lamination packs.

### RELATED APPLICATIONS

This patent application is a 35 U.S.C. § 371 National Stage entry of PCT/EP2022/085071, filed Dec. 8, 2022, which in turn claims priority based on German Patent Application DE 10 2022 102 821.6, filed Feb. 7, 2022, the disclosures of which are incorporated herein by reference.

### FIELD OF THE INVENTION

The invention relates to a method and device for producing lamination packs.

### BACKGROUND OF THE INVENTION

The production of lamination packs is known in particular for the production of iron cores for stators or rotors of generators or electric motors as well as for all devices in which an inductance is used by a coil wound around an iron core.

For this purpose, sheets are stamped out according to a desired shape and combined into lamination stacks, wherein the thickness of the lamination stacks corresponds to a desired thickness of an iron core.

The shape of the iron cores in this case is calibrated so that they can accommodate the required number of copper wire windings.

In order to produce such lamination packs, it is known in particular to feed a sheet metal strip made of an electrical sheet steel to a stamping device and to produce the sheet metal lamination by stamping it in the stamping device in a single-stage or multi-stage stamping process or more precisely, to stamp the sheet metal lamination out from the steel strip. A plurality of these laminations are then placed on top of one another in alignment and joined to form the lamination pack.

In particular, it is known to coat the sheet metal strip with a thermally activated polymer and, with the aid of heat, to bond a stack of stamped-out sheet metal laminations to one another, which stack is produced in this way or is produced from these laminations.

Such polymers are also referred to as bonding varnish and can be based on different synthetic resin compositions.

DE 10 2012 103 828 B4 discloses a device for stamping and forming packs and a method for producing a lamination pack. In this case, stamped sheets are stamped out of a sheet metal strip coated with a bonding varnish and are deposited stacked on top of one another below a final stamping stage or in a stacking channel, with the top stamped sheet being subjected to heat by a heating medium that is present in the stamping tool in such a way that it bonds with the stamped sheet situated below it. If a lamination pack has been produced with sheet metal laminations bonded to one another and is of sufficient height or thickness, then the next stamped sheet placed on top should not be bonded to the stack below it and instead, a new bonded stack should be formed so that stacks of the same height are always placed on top of one another and can be removed toward the bottom. The disadvantage of this device and method is that they are almost impossible to implement on a large scale. On the one hand, the bonding is not very reliable; on the other hand, it is possible that there is still so much heat in a lamination stack underneath that the bonding varnish of a sheet placed on top, which should absolutely not be bonded, will nevertheless be activated so that the stacks adhere together. Other bonding means, for example a lowerable inductor and the like, are also mentioned in this publication, but none of these devices is able to bring about reliable bonding on the one hand and reliable separation of the stacks on the other.

DE 38 29 068 C1 discloses a method for bonding electrical sheets, which are provided with an adhesive insulating layer (bonding varnish) and stamped in a machine, where the individual stamped parts are placed on top of one another and bonded together under the influence of heat and axial pressure. In order to reduce the time and energy required, each individual stamped part is to be heated to the reaction temperature of the bonding varnish during placement and then immediately pressed onto the previously deposited stamped part, wherein the stack is to be cooled once it has been completed. The disadvantage here is that the processing rates cannot be very high since a cooling step always has to be included.

CH 703 721 A1 discloses a method for producing bodies of stacked sheet metal, in which a stack is formed from the sheet metal laminations in a tool cavity, with thermally curing adhesive layers being provided between the sheet metal laminations. The sheet metal parts are then heated to cure the adhesive layers and form the sheet metal stack. The cavity in this case has a contour that at least partially corresponds to the contour of the sheet metal parts. Due to the material contact between the tool that forms the cavity and the sheet metal laminations, heat is introduced via the outer edge of the sheet metal laminations, which then causes the sheet metal parts to be thermally bonded together. The tool that forms the cavity is usually also referred to as a brake sleeve because the diameter of the cavity is selected so that the sheet metal laminations can only be moved through it against a certain amount of friction so that a force from below and a counterforce exerted from above by the stamping die ensure that the sheet metal laminations lie on top of one another in a form-fitting way.

DE 10 2012 005 795 A1 discloses a lamination pack and a method for producing it in which the lamination pack consists of stamped laminations that are bonded with an adhesive compound. The adhesive compound should consist of an adhesive and an initiator, which consists of methacrylates and other substances. The fully cured adhesive composite should be resistant over the long term at a temperature of at least over 80°. The adhesive is applied over the entire surface of one side of the lamination and the initiator is applied to the same side and/or to the other side of the lamination. The initiator reacts with the adhesive on contact and produces the adhesive bond between adjacent laminations. The adhesive compound can, however, also be an adhesive that cures automatically when subjected to heat. Pack separation should be achieved by not applying an initiator when packs are to be separated. The disadvantage of this method and this device is that the design is quite costly and complex.

WO 2020/053230 A1 discloses a method and a device for joining sheet metal parts to form sheet metal packs. In this instance, sheet metal parts are joined to form sheet metal packs, wherein a sheet metal strip, which has a curable polymeric adhesive layer on its top surface and/or bottom surface, is continuously transported through an application device in which a fluid containing an activator is applied to the adhesive layer, the applied fluid dries, and the sheet metal strip coated with the dried activator is continuously fed to a strip storage receptacle, wherein the sheet metal strip is fed from the strip storage receptacle to a cyclical separating device, in particular a stamping unit, in which the sheet metal parts are separated from the sheet metal strip and stacked on top of one another and the separated and stacked sheet metal parts are joined together to form lamination packs by means of the adhesive layer that is coated with the activator. The stamped-out sheet metal parts are stacked on top of one another in a column-shaped brake sleeve. The heatable inner wall of the brake sleeve has a slightly tapered profile toward the bottom so that the brake sleeve exerts resistance on the stacked sheet metal parts in the manner of a stack brake. One wall section of the brake sleeve is heated by a heater so that the sheet metal parts are heated above the curing temperature of the bonding varnish and the sheet metal parts are joined together through application of heat and pressure. For this purpose, the brake sleeve is surrounded by a heater or has an internal heater, which heats the sheet metal parts in the line to a temperature above the cross-linking temperature of the applied bonding varnish and thus ensures that the individual sheet metal parts are joined by means of the cured bonding varnish layer between successive sheet metal parts to form sheet metal packs.

### SUMMARY OF THE INVENTION

The object of the invention is to create a process with which lamination packs can be produced with improved reliability.

The object is attained by a method with the features described and claimed herein.

Advantageous modifications of the method are also described and claimed herein.

A further object is to create a device that can be used to more reliably join lamination packs to one another.

The object is attained by a device with the features described and claimed herein.

Advantageous further embodiments of the device are also described and claimed herein.

The invention is based on a device and a method in which lamination packs are produced by baking, i.e. thermal activation of the bonding varnish, in a brake sleeve that is positioned under a final stamping stage.

The inventors have discovered that in devices of this kind, in which a heat activation takes place through the introduction of heat via the outer edges of the sheet metal laminations, a reliable thermal bonding of the lamination packs does not always occur.

It has been discovered that this is particularly the case when due to the shape of the sheet metal laminations, the outer edges of the sheet metal laminations are reduced in size to such an extent that the heat conduction from the outer edge to the center of the sheet metal lamination is not sufficient, particularly in the given time, to reliably heat the bonding varnish over the entire surface or at least over a desired surface. This can be caused by the fact that the outer edges that are suitable for a possible heat conduction are reduced in size because of openings that are required for a subsequent copper winding.

In addition, the brake sleeve according to the invention is heated with thermocouples, i.e.

electrically, wherein such heating systems do function reliably for the most part, but in the event of a failure, a deteriorated thermal bonding would not be immediately noticeable.

According to the invention, an additional heater is therefore provided. The additional heater according to the invention takes advantage of the fact that rotor and stator packs have a central axial through opening for accommodating a motor shaft or the rotor (in the case of a stator).

On the other hand, the packs are removed from the bottom of the brake sleeve or fall onto a conveyor belt, making it impossible for a heater to be permanently installed in the cavity inside the brake sleeve.

According to the invention, therefore, an inductor device is inserted into the cavity of the stacked lamination packs in the brake sleeve and is retracted again when a lamination pack is to be ejected so as not to hinder the output of the lamination packs. The insertion and retraction of the inductor device is timed so that each lamination pack has been heated at least once by the inductor device.

According to the invention, both the heating of the brake sleeve and the insertion depth of the inductor device from below into the lamination stack are coordinated so that the heating by the inductor device takes place only in the region in which a heating by the brake sleeve also takes place. The heating of the brake sleeve and thus also the heating by the inductor device is carried out spaced apart from the stamping die by a distance that is at least great enough to prevent accidental heating of the stamping device or premature activation of the bonding varnish in the region of the stamping die. In addition, the dimensional stability of the individual laminations and thus also of the finished packs can be further improved since no thermal expansion is applied. In particular, areas of the stamping device that are also provided with lubrication should not be heated in order to prevent heating of the lubricants. This serves in particular to ensure that the heating takes place at the locations where the lamination packs are subjected to enough pressure to ensure reliable thermal bonding. The distance from the stamping die is 100 to 150 mm, for example, although the distance also depends on the tools.

Instead of an inductor device, a suitable radiant heater can also be used. Alternatively or additionally, heating from the inside can also be achieved by injection of a hot fluid.

A desired separation of the lamination packs is achieved by placing a so-called puck in the brake sleeve after a desired number of stamped-out laminations have been placed in it. The puck is a metal or plastic disk that is coated or made of a material that prevents it from adhering to the lamination below or above it when the bonding varnish is activated. The pucks fall down out of the brake sleeve after the lamination packs have been removed and can be collected and returned. The pucks have at least one axial opening, which is dimensioned in such a way that the inductor device can also be guided through the pucks.

The inductor device is advantageously synchronized in such a way that it enters the brake sleeve immediately after a finished lamination pack (with pucks) has been ejected downward from the brake sleeve and carried away and with a sufficient time interval before the next lamination pack is ejected.

The inductor device here can be already active when inserted or can be activated only during insertion.

Advantageously, the inductor device is already active before the upper turning point of the insertion movement is reached.

The inductor device is advantageously controlled in such a way that it is not active in its lowest home position. It is also advantageous that the inductor device is switched off as it leaves the brake sleeve and after exiting from the last lamination pack.

Depending on the speed of the stamp and the number of lamination packs, the lamination packs are heated at least once with the inductor device, but can also be heated several times without causing damage.

The advantage of the invention is that it achieves a simple, uncomplicated, very reliable thermal bonding of lamination packs.

The invention thus relates in particular to a method for stamping and forming packs of sheet metal laminations coated with a bonding varnish to form lamination packs, wherein a brake sleeve is provided in which the sheet metal laminations of the lamination packs, lying on top of one another and with outer edges resting against the inside of the brake sleeve, are acted on with heat from the brake sleeve via the outer edges of the sheet metal laminations so that the bonding varnish is thermally activated, bonding the laminations to one another, characterized in that an additional device for heating the lamination packs is at least temporarily positioned in an axial channel formed by the lamination packs in order to additionally heat the lamination packs.

According to one modification, an inductor device is used as the device for heating the lamination packs.

According to one modification, a radiant heating device is used as the device for heating the lamination packs.

According to one modification, a hot heating fluid, which is injected into the channel formed by the lamination packs, is used as the device for heating the lamination packs.

According to one modification, a contact pressure ring acting on the lamination stacks from the outlet of the brake sleeve cis used as a counter bearing for a stamping die, wherein the contact pressure ring is moved away from the outlet together with a lamination stack that has been ejected from the brake sleeve in order to carry out a lateral discharge of the ejected lamination stack and, after the ejected lamination stack has been discharged, is moved back into the brake sleeve and produces a mechanical contact with the bottom lamination stack.

As defined in the invention, “lamination stack (14)” describes a stack of individual sheet metal laminations that are not yet—or at least not yet fully—thermally glued or bonded. As defined in the invention, “lamination pack (15)” refers to fully bonded packs.

According to one modification, the inductor device (11) or radiant heating device is moved downward out of the outlet (4) of the channel (16) in order to discharge a lamination stack to be ejected, which still consists of individual, unbonded sheet metal laminations (14).

In a further aspect, the invention relates to a device for stamping and forming packs of sheet metal laminations coated with a bonding varnish to form lamination packs, with a brake sleeve that has an axial stacking channel for receiving sheet metal laminations, wherein the brake sleeve is heated in order to radiate heat into the sheet metal laminations via the outer edges of the sheet metal laminations in order to activate the bonding varnish, wherein an additional device for heating the sheet metal laminations and lamination packs is at least temporarily positioned in an axial channel formed by the lamination packs in order to additionally heat the lamination packs.

According to one modification, an inductor device is provided as a device for heating the lamination packs.

According to one modification, a radiant heating device is provided as a device for heating the lamination packs.

According to one modification, an injection device for a hot heating fluid, which is positioned so that it injects a hot fluid from an outlet of the brake sleeve into the channel formed by the lamination packs, is provided as the device for heating the lamination packs.

According to one modification, below the outlet, a pusher is provided, which is displaceable transversely to the longitudinal axis of the brake sleeve and in particular is positioned directly below the outlet of the brake sleeve, wherein in the home position of the pusher, it is retracted far enough that that it does not protrude into the region of the stacking channel.

According to one modification, the device for stamping and forming packs has a contact pressure ring, which can be moved along the longitudinal axis of the brake sleeve and has an outer diameter that corresponds to or is slightly smaller than the inner diameter of the brake sleeve or stacking channel so that it can be inserted all the way into the stacking channel, in particular up to the inlet (3).

According to one modification, the inductor device is at least partially cylindrical and has an outer diameter that is smaller than the inner diameter of the contact pressure ring so that the inductor device can be moved through the contact pressure ring and so that the inductor device is concentric to the longitudinal axis of the brake sleeve and can be moved into the brake sleeve through the contact pressure ring.

According to one modification, the contact pressure ring and inductor device or radiant heating device can be moved independently of each other, wherein both can be actuated via a corresponding mechanism with electric actuators.

### BRIEF DESCRIPTION OF THE DRAWINGS

The invention will be explained by way of example with the aid of the drawings. In the drawings:

FIG. 1: shows a highly schematic top view of a heated brake sleeve with sheet metal laminations therein and the associated section along line A-A with the inductor device moved into the brake sleeve;

FIG. 2: shows a highly schematic top view of a heated brake sleeve with sheet metal laminations therein and the associated section along line B-B with the inductor device moved out from the brake sleeve;

FIG. 3: shows a highly schematic top view of a heated brake sleeve with sheet metal laminations therein and the associated section along line C-C with inductor device moved out from the brake sleeve and a pusher for displacing an ejected lamination pack with a displaced lamination pack;

FIG. 4: shows a highly schematic top view of a heated brake sleeve with sheet metal laminations therein and the associated section along line D-D with the inductor device moved out from the brake sleeve and the pusher retracted.

### DETAILED DESCRIPTION OF THE INVENTION

According to the invention, a device 1 stamping and forming packs is provided, which has a brake sleeve 2. In particular, the brake sleeve 2 is cylindrical with a round cross-section and has an inlet 3 and outlet 4. The hollow cylindrical stacking channel 5 is formed between the inlet 3 and outlet 4. Outside a cylindrical wall 6 of the brake sleeve, thermocouples 7 are distributed around the circumference as heating elements and rest with one surface against the outer circumferential surface of the outer wall of the wall 6 of the brake sleeve.

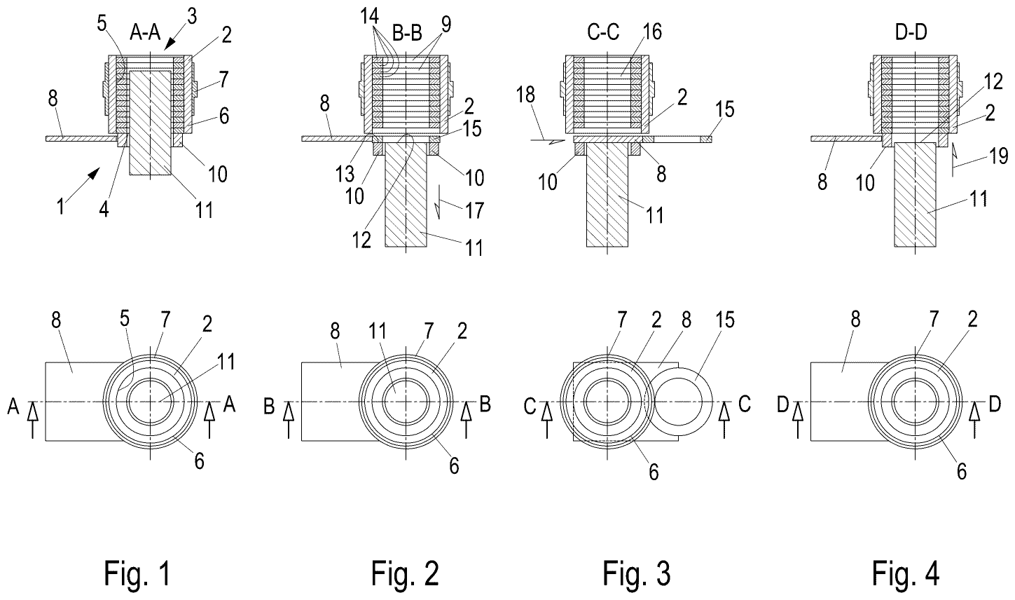

Below the outlet 4, a pusher 8 is provided, which can be moved transversely to the longitudinal axis of the brake sleeve 2 and in particular, is positioned directly below the outlet 4 of the brake sleeve 2. In a home position of the pusher 8 shown in FIG. 1, it is retracted far enough that that it does not protrude into the region of the stacking channel 5. In addition, the device for stamping and forming packs has a contact pressure ring 10, which can be moved along the longitudinal axis of the brake sleeve 2 and has an outer diameter that corresponds to or is slightly smaller than the inner diameter of the brake sleeve so that it can be inserted all the way into the stacking channel 5, in particular up to the inlet 3.

In addition, the device 1 for stamping and forming packs has an inductor device 11, wherein the inductor device 11 is shown in simplified form as a cylinder in the figures. As already explained, the inductor device 11 is cylindrical, for example, and has an outer diameter that is smaller than the inner diameter of the contact pressure ring 10 so that the inductor device can be moved through the contact pressure ring. Otherwise, the inductor device 11 is positioned concentrically to the longitudinal axis of the brake sleeve 2 and can in particular be moved into the brake sleeve 2 through the contact pressure ring 10 (FIG. 1).

Multiple lamination stacks 14 are positioned in succession inside the brake sleeve 2 and in particular inside the stacking channel 5 and are formed from individual laminations that stacked on top of one another (not shown). So-called pucks 9 are provided as spacer elements between the lamination stacks 14.

The lamination stacks 14 are usually in the form of a flat ring and correspondingly have an axial or concentric central opening relative to the brake sleeve 2. Accordingly, all of the concentric openings form a channel 16, which has an inner diameter that is larger or slightly larger than the outer diameter of the inductor device 11.

The contact pressure ring 10 and inductor device 11 can be moved independently of each other, although the movements are coordinated with each other. In particular, the two elements can be actuated via a corresponding mechanism with electric actuators (not shown).

As can be seen in FIGS. 1 and 4, the purpose of the contact pressure ring 10 is to exert pressure on the lamination stacks 14 from below, i.e. on the outlet side, wherein the pressure is produced on the inlet side by the fact that the stamping die of a stamping device (not shown) exerts pressure on the stamped sheet metal laminations onto already stamped sheet metal laminations positioned below them or onto a puck positioned below them.

The inner diameter of the brake sleeve 2 is dimensioned so that it is slightly smaller than the outer diameter of the stamped packs so that they are moved from the inlet to the outlet with friction, but in any case with a form-fit inside the brake sleeve 2. This form-fit holds the packs until they come out of the brake sleeve in the region of the outlet and are pressed out, so to speak, by the stamping stroke of the stamping device. In order to be able to subsequently process the lamination packs 15 further, the contact pressure ring 10 is controlled in such a way that when a lamination pack 15 is just about to be ejected, the ring moves a short way downward, i.e. away from the outlet 4, or moves downward together with an ejected lamination pack 15, picking it up.

The inductor device 11 (FIG. 1), which was previously positioned in the channel 16 formed by the lamination stacks 14, also moves out of the channel 16 in the direction of arrow 17 (FIG. 2), preferably in such a way that a surface 12 on the brake sleeve side, in particular a flat one, is flush with a surface 13 of the contact pressure ring 10 on the outlet side. This forms a support surface onto which the ejected lamination pack 15 can fall or be supported. The pusher 8 then pushes this lamination pack 15 (FIG. 3) out laterally in the direction of arrow 18, in particular, pushing it onto a conveyor belt (not shown). The corresponding pucks 9, if they have also fallen out, are then also pushed onto a conveyor belt or another conveyor device along with the lamination pack 15.

The procedure and method will be explained below.

At the beginning, the contact pressure ring 10 is raised all the way or is moved all the way into the stacking channel 5 as far as the inlet 3 in order to form a support for a first stamped-out lamination. The stamping device positioned above the inlet 3, which can also be embodied with multiple stages (not shown), then begins to stamp out the corresponding laminations, wherein in the last stamping stage, the stamping die moves the lamination into the stacking channel 5 of the brake sleeve 2 and presses it in. In order to prevent the laminations from tipping or tilting, they—and in particular the first lamination—rest on the contact pressure ring 10.

If enough laminations to form a complete lamination pack 15 have been stamped, then a puck 9 is inserted, which is a sheet metal or plastic element with a surface embodied in such a way that the bonding varnish with which the laminations are coated cannot bond with this puck 9. If necessary, a puck is also placed on the contact pressure ring 10 first in order to prevent the bottom lamination stack 14 from sticking or more precisely stated, to prevent the bottom lamination resting on the contact pressure ring 10 from sticking to the contact pressure ring 10. Enough lamination stacks 14 with pucks 9 between them are then formed for the contact pressure ring 10 to reach the region of the outlet 4. The subsequent laminations, which are pressed into the inlet 3 of stacking channel 5, then press the contact pressure ring 10 down into the inlet 3 from above and it can then move downward so that the lamination packs 15 that have been completed can fall onto it or be guided downward together with the contact pressure ring 10 (FIG. 2).

While the laminations are pressed into lamination stacks 14 and then bonded to one another through activation of the bonding varnish with heating by means of the thermocouples 7, the inductor device 11, as shown in FIG. 1, is pushed all the way into the brake sleeve 2, but at a distance from the inlet 3, and thus into the channel 16 formed by the lamination packs.

Before a finished lamination pack 15 is conveyed out of the brake sleeve 2, the inductor device 11 moves downward in the direction of arrow 17 all the way to the level of the contact pressure ring 10 and forms a combined surface or support surface together with it so that the finished, ejected lamination pack 15 can be supported on it.

The moment that the lamination pack 15 is conveyed out of the brake sleeve 2 resting on the contact pressure ring, the pusher 8 pushes this lamination pack 15 laterally out of the region under the brake sleeve 2 and on the contact pressure ring 10 and inductor device 11 in the direction of arrow 18 in FIG. 3, together with the pucks 9 so that they can be conveyed away on a conveyor belt. The pusher 8 then returns to its starting position (FIG. 4).

The contact pressure ring 10 is brought back into contact with the bottom lamination stack 14 and then the inductor device 11 moves back into the channel 16 formed by the lamination stack 14 in the direction of arrow 19 in FIG. 4 and is switched on during or before this.

The inductor device 11 preferably maintains a certain distance from the stamping device (not shown) positioned above the brake sleeve 2 and from the inlet 3 in order to ensure that no undesirable heating takes place in the stamping region and inlet region, for example in order not to overheat lubricants or the like. As already mentioned, the distance can be between 10 and 15 cm.

The inductor device 11 can be switched on when it is inserted into the channel 16 and switched off again when exiting, but the inductor device 11 can also be in operation the entire time.

Instead of an inductor device 11, a radiant heating device can also be provided, with an appropriately embodied radiant heater being inserted into the channel 16. Additionally or alternatively, heating by injecting a hot fluid is also possible.

The invention has the advantage of creating a device with which lamination stacks 14 are reliably heated from the outside by the brake sleeve 2 and from the inside by the inductor device 11 in such a way that reliable bonding of the bonding varnish and thus of the lamination packs 15 is ensured.

1-15. (canceled)

16. A method for stamping and forming lamination packs (15) of sheet metal laminations coated with a bonding varnish, comprising the steps of:
providing a brake sleeve (2);
providing lamination stacks (14) in the brake sleeve (2), each lamination stack (14) including a plurality of sheet metal laminations lying on top of one another and having outer edges resting against an inside of the brake sleeve (2), the lamination stacks (14) defining an axial channel (16);
at least temporarily positioning an additional device (11) in the axial channel (16) defined by the lamination stacks (14);
applying heat from the brake sleeve to the outer edges of the sheet metal laminations in each lamination stack (14); and
applying additional heat from the additional device (11) to the lamination stacks (14);
wherein the heat applied from the brake sleeve (2) and the additional device (11) causes thermal activation of the bonding varnish to bond the sheet metal laminations in each lamination stack (14) to each other to yield the lamination packs (15).

17. The method according to claim 16, wherein the additional device (11) comprises an inductor device.

18. The method according to claim 16, wherein the additional device (11) comprises a radiant heating device.

19. The method according to claim 16, wherein the additional device (11) comprises a hot heating fluid injected into the axial channel (16).

20. The method according to claim 16, further comprising:
providing a contact pressure ring (10) acting on the lamination stacks (14) from an outlet (4) of the brake sleeve (2), the contact pressure ring (10) acting as a counter bearing for a stamping die;
wherein the contact pressure ring (10) is moved away from the outlet (4) together with a lamination pack (15) when the laminated pack (15) is ejected from the brake sleeve to enable a lateral discharge of the ejected lamination pack (15) and, after the lateral discharge, is moved back into contact with the brake sleeve (2).

21. The method according to claim 16, wherein the additional device (11) comprises an inductor device or radiant heating device;
further comprising moving the additional device (11) downward out of the outlet (4) of the axial channel (16) in order to discharge a lamination pack (15).

22. A device for stamping and forming packs of sheet metal laminations coated with a bonding varnish to yield lamination packs (15), comprising:
a brake sleeve (2) having an axial stacking channel (5) for receiving lamination stacks (14) of sheet metal laminations lying on top of one another, with outer edges resting against an inside edge of the brake sleeve (2), the lamination stacks (14) defining an axial channel (16); and
an additional device (11) at least temporarily positioned in the axial channel (16);
wherein the brake sleeve (2) and the additional device (11) are heated in order to heat the sheet metal laminations in each lamination stack (14), activate the bonding varnish, and bond the sheet metal laminations to each other to yield the lamination packs (15).

23. The device according to claim 22, wherein the additional device (11) comprises an inductor device.

24. The device according to claim 22, wherein the additional device (11) comprises a radiant heating device.

25. The device according to claim 22, wherein the brake sleeve (2) further comprises an outlet (4) and the additional device (11) comprises an injection device positioned to inject a heating fluid from the outlet (4) into the axial channel (16).

26. The device according to claim 22, wherein the brake sleeve (2) further comprises an outlet (4), the device further comprising a pusher (8) positioned below the outlet (4) and displaceable transversely to a longitudinal axis of the brake sleeve (2).

27. The device according to claim 26, wherein the brake sleeve (2) further comprises a stacking channel (5) and the pusher (8) has a retracted home position where it does not protrude into the stacking channel (5).

28. The device according to claim 23, further comprising a contact pressure ring (10) movable along a longitudinal axis of the brake sleeve (2), the contact pressure ring (10) having an outer diameter that corresponds to or is slightly smaller than an inner diameter of the brake sleeve (2).

29. The device according to claim 28, wherein the inductor device is at least partially cylindrical and has an outer diameter that is smaller than an inner diameter of the contact pressure ring (10) so that the inductor device can be moved through the contact pressure ring (10), the inductor device being concentric to the longitudinal axis of the brake sleeve (2).

30. The device according to claim 28, further comprising one or more electric actuators, wherein the contact pressure ring (10) and inductor device can be moved independently of each other and can be actuated using the one or more electric actuators.

31. The device according to claim 28, wherein the inductor device is at least partially cylindrical and has an outer diameter that is smaller than an inner diameter of the contact pressure ring (10) so that the inductor device (11) can be moved through the contact pressure ring (10), the inductor device (11) being concentric to the longitudinal axis of the brake sleeve (2).

32. The device according to claim 24, further comprising a contact pressure ring (10) which is movable along a longitudinal axis of the brake sleeve (2), the contact pressure ring (10) having an outer diameter that corresponds to or is slightly smaller than an inner diameter of the brake sleeve (2).

33. The device according to claim 32, further comprising one or more electric actuators, wherein the contact pressure ring (10) and radiant heating device can be moved independently of each other and can be actuated using the one or more electric actuators.

34. A method for stamping and forming lamination packs (15) of sheet metal laminations coated with a bonding varnish, comprising the steps of:
providing a brake sleeve (2) including a stacking channel (5), an inlet (3), and an outlet (4);
providing lamination stacks (14) in the stacking channel (5) of the brake sleeve (2), each lamination stack (14) including a plurality of sheet metal laminations lying on top of one another and having outer edges resting against an inside of the brake sleeve (2), the lamination stacks (14) defining an axial channel (16);
at least temporarily positioning an additional device (11) in the axial channel (16) defined by the lamination stacks (14);
applying heat from the brake sleeve to the outer edges of the sheet metal laminations in each lamination stack (14); and
applying additional heat from the additional device (11) to the lamination stacks (14);
wherein the heat applied from the brake sleeve (2) and the additional device (11) causes thermal activation of the bonding varnish to bond the sheet metal laminations in each lamination stack (14) to each other to yield the lamination packs (15), and the additional device (11) comprises one or more of an inductor device, a radiant heating device, and an injection device for injecting a heated fluid in the axial channel (16).

35. The method of clam 34, further comprising placing one or more pucks (9) between adjacent lamination stacks (14) in the stacking channel (5) to prevent the adjacent laminated stacks (14) from bonding to each other.
